(19) United States
(12) Patent Application Publication
(10) Pub. No.: US 2009/0303309 A1
(43) Pub. Date: Dec. 10, 2009

(54) MOBILE TERMINAL AND METHOD FOR TRANSMITTING VIDEO DATA IN VIDEO TELEPHONY SYSTEM

(75) Inventor: Ohyoon Kwon, Seoul (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 12/477,556

(22) Filed: Jun. 3, 2009

(30) Foreign Application Priority Data
Jun. 4, 2008 (KR) 10-2008-0052632
Apr. 15, 2009 (KR) 10-2009-0032625

(51) Int. Cl. H04N 7/14; H04J 3/08; H04B 1/66

(52) U.S. Cl. 348/14.02; 370/315; 375/240.13; 348/E07.081; 375/E07.026

(57) ABSTRACT

A method for transmitting video data in a video telephony system includes generating an intra frame at a first interval, transmitting the intra frame to a receiving terminal, and generating the intra frame at a second interval if data transmission with the receiving terminal is possible. The first interval may be shorter than the second interval.

### CROSS-REFERENCE TO RELATED APPLICATIONS

This application claims priority from and the benefit of Korean Patent Application No. 10-2008-0052632, filed on Jun. 4, 2008 and Korean Patent Application No. 10-2009-0032625, filed on Apr. 15, 2009, the disclosures of which are hereby incorporated by reference for all purposes as if fully set forth herein.

### BACKGROUND OF THE INVENTION

1. Field of the Invention

The present invention relates to a method for transmitting video data in a video telephony system and mobile terminal to perform the method, and more specifically, to a method for reducing the risk of poor early stage video quality in a video telephony system, and a mobile terminal to perform the method.

2. Discussion of the Background

With the rapid progress of computer, electronic, and communication technologies, various types of wireless communication services utilizing a wireless network have been implemented. The most basic wireless communication service is a wireless voice communication service that permits wireless voice communication between mobile terminal users with minimal restrictions on a time and a place.

The current rising use of wireless Internet service also provides a communication service using the Internet via a wireless network, allowing a mobile terminal user to freely move with minimal restrictions on a physical location. Accordingly, mobile communication subscribers have the ability to communicate with other parties using the wireless communication service while freely moving to any one of many different locations. Also, the subscribers can receive information via the wireless Internet service, for example, news, weather, sports, stocks, foreign exchange, traffic information, and the like through various methods, such as text, voice, image, and the like.

A video telephony system denotes a system that includes a wireless voice communication service function, a wireless Internet service function, and the like. The video telephony system may be installed in a mobile terminal. A conventional video telephony system will be described in detail with reference to FIG. 3.

FIG. 3 is a diagram for describing a video telephony system according to the conventional art. Here, arrow indicator \textcircled{1} denotes an intra frame and arrow indicator \textcircled{2} denotes an inter frame. The intra frame denotes an encoded video frame in a frame and the inter frame denotes a prediction encoded video frame between intra frames.

Referring to the video telephony system in FIG. 3, when video telephony is initiated or attempted between terminal A 310 and terminal B 330 that use different video telephony access programs, a video call access can be performed between terminal A 310 and terminal B 330 via a protocol gateway 320.

In this case, terminal A 310, representing a calling mobile terminal, recognizes the gateway 320 as a receiving terminal, that is, terminal B 330. Also, terminal B 330, representing a receiving mobile terminal, recognizes the gateway 320 as a calling terminal, that is, terminal A 310. Accordingly, terminal A 310 and terminal B 330 generate two video calls via two different video telephony protocols.

In a conventional video telephony system, since access points in time of two video calls are different from each other, it is unlikely that image data transmission channels would be simultaneously opened. In this case, an intra frame transmitted from terminal A 310 in the initial stage of video telephony through the gateway 320 may be dropped, therefore does not reach the terminal B 330. In FIG. 3, this intra frame is shown as the first intra frame transmitted from terminal A 310, and is represented by a dashed-line arrow from gateway 320. As shown, this arrow does not reach terminal B 330, and this represents that the first intra frame is dropped.

If compressed video data of an intra frame gets dropped while passing through a gateway 320, a mobile terminal of a counter party, such as terminal B 330, may attempt to recover a video using only an inter frame until the mobile terminal of the counter party receives a subsequent intra frame. The video recovered from only an inter frame may be severely degraded. To the contrary, terminal A 310 could send an intra frame continuously to prevent this sort of video degradation, but the amount of data transmitted may exceed the capacity of a limited transmission channel, or an excessive number of intra frames may be generated. This process may also result in video degradation.

### SUMMARY OF THE INVENTION

This invention provides a method and system for video data transmission that may adjust the transmission interval of an intra frame during a video call to thereby reduce the risk of video degradation and improve video quality in a receiving terminal in the early stage of video telephony.

The present invention also provides a method for adjusting the transmission interval of an intra frame during a video call to reduce the risk of an intra frame from getting dropped.

The present invention further provides a method for reducing the risk of video degradation that may occur as a result of an intra frame getting dropped in an early stage of video telephony.

The present invention further provides a mobile terminal to adjust the transmission interval of an intra frame during a video call to thereby reduce the risk of video degradation in a receiving terminal in the early stage of video telephony.

Additional features of the invention will be set forth in the description which follows, and in part will be apparent from the description, or may be learned by practice of the invention.

The present invention discloses a method for transmitting video data in a video telephony system by generating an intra frame at a first interval, transmitting the intra frame from a calling terminal to a receiving terminal, and generating the intra frame at a second interval to transmit the generated intra frame to the receiving terminal.

The present invention also discloses a mobile terminal, including a video codec to generate an intra frame and an inter frame for performing video telephony; an image sensor to capture image data; a display; and a radio frequency (RF) transceiver to transmit and receive data, wherein the video codec generates the intra frame at a first interval after determining that video data transmission with a gateway is possible, and generates the intra frame at a second interval after determining that video data transmission with a receiving terminal is possible.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram describing a video telephony system according to an exemplary embodiment of the present invention.

FIG. 2 is a flowchart illustrating a method for improving the early stage video quality in a video telephony system according to an exemplary embodiment of the present invention.

FIG. 3 is a diagram for describing a video telephony system according to the conventional art.

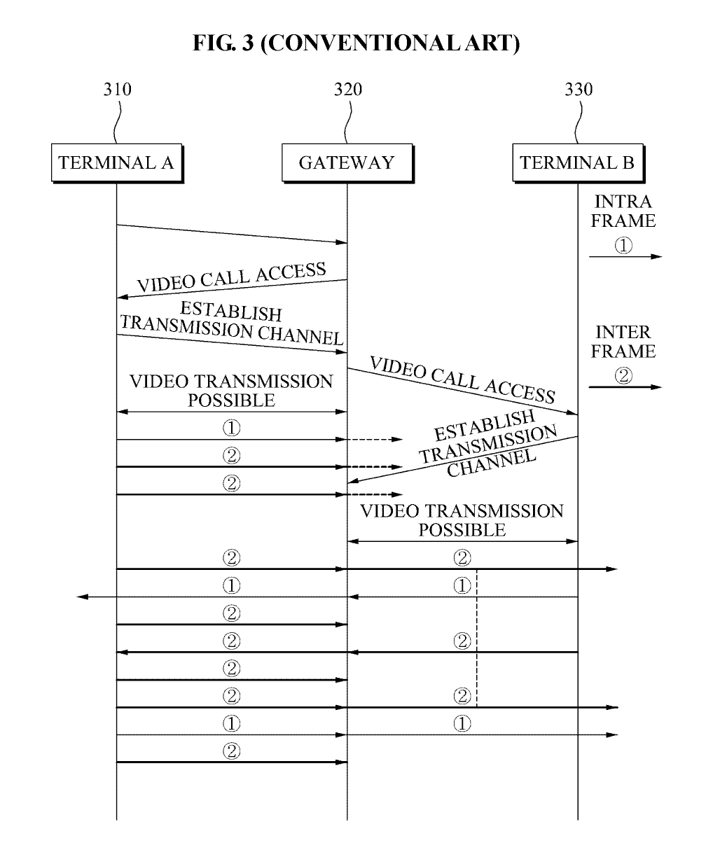

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Unless specifically defined, terms used throughout the present specification will have the meaning recognized by one of ordinary skill in the conventional art.

The term “intra frame” denotes an independent type frame that may be independently decoded without referring to other images. Therefore, the intra frame may consume a lot of bits. A first frame in a video sequence stream is generally the intra frame. The intra frame may be the starting point of a re-synchronization for a new viewer or when a transmitted bitstream is damaged. The intra frame may be used to configure a forward function, a rewind function, and/or a random play function.

The term “inter frame” denotes a prediction between frames, and may encode a frame by referring to a previous I-frame and/or P-frame. Specifically, the inter frame may compress information by initially storing information associated with a key frame, that is, the intra frame, and by storing only a different point of the key frame with respect to subsequent frames. Accordingly, the inter frame may have a higher compression rate than the intra frame.

Here, terminal A denotes a calling terminal that may transmit the intra frame, the inter frame, and the like, and use a packet switching based protocol such as H.323, a Session Initiation Protocol (SIP), and the like. Terminal A may include a video codec to generate an intra frame and an inter frame for performing video telephony, an image sensor to capture image data, a display, and a radio frequency (RF) transceiver to transmit and receive data to and from another terminal and a gateway.

Terminal B denotes a receiving terminal that may receive the intra frame, the inter frame, and the like, from the calling terminal. Terminal B may use a video telephony communication protocol that is different from the calling terminal, that is, a circuit switching based protocol such as H.324, H.324M, 3G-324M, and the like.

A gateway denotes a device that may transcode a video codec, or may convert a protocol to support a connection between terminal A using a packet switching network and terminal B using a circuit switching network, or vice-versa.

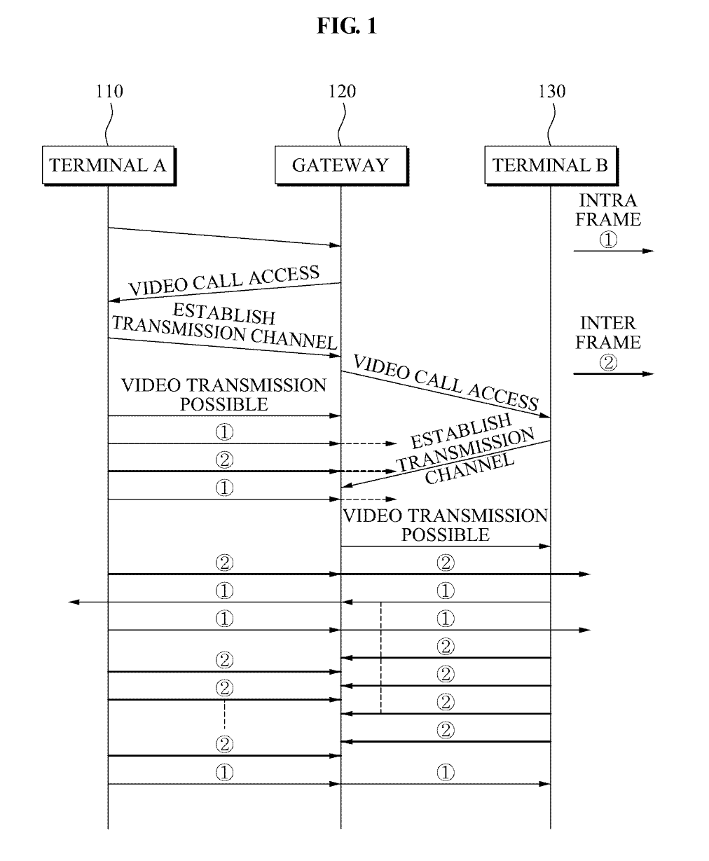

FIG. 1 is a diagram for describing a video telephony system according to an exemplary embodiment of the present invention, where arrow indicator \textcircled{1} denotes an intra frame and arrow indicator \textcircled{2} denotes an inter frame.

Referring to FIG. 1, in order to attempt a video telephony session with terminal B 130, terminal A 110 may attempt a video call access to a gateway 120 that is positioned between terminal A 110 and terminal B 130.

Terminal A 110 may attempt to establish a transmission channel with the gateway 120. When a transmission channel with the gateway 120 is established and a video transmission with the gateway 120 is possible, terminal A 110 may start transmitting an intra frame.

In this instance, the intra frame may cause early stage quality degradation in compressed video data if terminal B 130 does not receive the intra frame and instead attempts to recover the compressed data by decoding a subsequently transmitted inter frame. Accordingly, terminal A 110 may transmit the intra frame at a first interval, for example, once every two frames. The other frame in this alternating sequence is an inter frame.

The gateway 120 may attempt video call access with terminal B 130 in interoperation with establishing the transmission channel between terminal A 110 and the gateway 120. When the video call access with the gateway 120 is completed, terminal B 130 may attempt to establish a transmission channel with the gateway 120.

In this instance, when the transmission channel with the gateway 120 is established and, in turn, video transmission with terminal B 130 is possible, terminal A 110 may set a generation interval of the intra frame to a second interval, for example, once every twenty frames, and may transmit the intra frame at the second interval. The other frames, such as nineteen out of twenty frames, are inter frames.

Specifically, terminal A 110 may transmit the intra frame at a first interval before the point in time when video data transmission with terminal B 130 is possible, and may transmit the intra frame at a second interval after the point in time when video data transmission with terminal B 130 is possible.

Accordingly, after the point in time when video data transmission is possible, terminal B 130 may decode video data using the intra frame received from terminal A 110. Through this, because an intra frame from terminal A 110 may be received by terminal B 130 more quickly than according to the conventional art, it is possible to reduce the risk of video data degradation that may occur in the early stage of video telephony.

Terminal A 110 may receive an indicator message from terminal B 130 that video transmission with terminal B 130 is possible. For example, once terminal A 110 receives a first intra frame from terminal B 130, terminal A 110 may determine that video data transmission with terminal B 130 is possible. At this point, terminal A 110 may shift from transmitting the intra frame at the first interval to transmitting the intra frame at the second interval. Additionally, the transmission of intra frames may be more frequent in the first interval than in the second interval.

As described above, a video telephony system according to an exemplary embodiment of the present invention may adjust a generation interval of an intra frame based on in time when video data transmission between terminal A 110 and terminal B 130 is possible. For example, the transmission interval may be a first interval of once every two frames before the point in time when video transmission with terminal B 130 is possible, and the transmission interval may be a second interval of once every twenty frames after the point in time when video transmission with terminal B 130 is possible, and the like.

Through this, it is possible to reduce the risk of video degradation that may occur as a result of a video decoder of terminal B 130 that does not appropriately recover initial compressed video data due to loss of an intra frame.

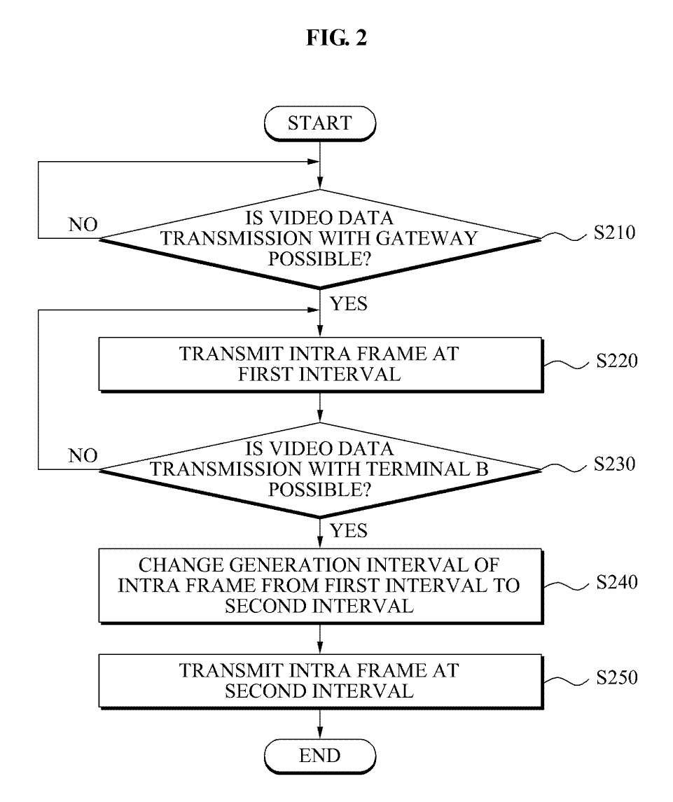

FIG. 2 is a flowchart illustrating a method of improving early stage video quality in a video telephony system according to an exemplary embodiment of the present invention.

Referring to FIG. 1 and FIG. 2, in operation S210, terminal A 110 may determine whether video data transmission with terminal B 130 is possible via the gateway 120.

For this, terminal A 110 may verify whether a data transmission channel with the gateway 120 is established via a call setup process. If the data transmission channel is established between terminal A 110 and gateway 120, terminal A 110 may determine the video data transmission with the gateway 120 is possible. Conversely, if the data transmission channel is not established, terminal A 110 may determine the video data transmission with the gateway 120 is not possible.

If the video data transmission is possible with gateway 120, that is, a “yes” direction in operation S210, terminal A 110 may generate an intra frame at a first interval to transmit the intra frame to terminal B 130.

The first interval denotes a generation interval of the intra frame and may be shorter than a second interval, which will be described later. Also, the first interval may also be shorter than the general generation interval of the intra frame. Specifically, terminal A 110 may transmit the intra frame to terminal B 130 by setting the first interval to be shorter than the second interval. In this instance, “interval” may represent the time between the generation or transmission of two intra frames. Also, terminal A 110 may transmit the intra frame to terminal B 130 by setting the first interval to be shorter than the generation interval of the general intra frame.

For example, terminal A 110 may set the generation interval of the intra frame to “once every two frames” and generate the intra frame “once every two frames” according to the set generation interval to thereby transmit the generated intra frame to terminal B 130. Specifically, terminal A 110 may alternatively transmit the intra frame and the inter frame to terminal B 130.

As described above, after the point in time when video data transmission with the gateway 120 is possible, terminal A 110 may set the generation interval of the intra frame to be short and thereby more frequently transmit the intra frame to terminal B 130.

According to an exemplary embodiment of the present invention, it is possible to recover original video data in an early stage of video telephony. Through this, it is possible to reduce the risk of video degradation in a receiving terminal that may occur due to loss of the intra frame.

Conversely, when the video data transmission is impossible, that is, a “no” direction in operation S210, terminal A 110 may maintain a standby state until video data transmission becomes possible.

In operation S230, terminal A 110 may determine whether video data transmission with terminal B 130 is possible. Specifically, terminal A 110 may determine whether the intra frame is received from terminal B 130.

In this instance, terminal A 110 may verify whether a data transmission channel between terminal A 110 and terminal B 130 is established. For example, terminal A 110 may verify whether the data transmission channel between terminal A 110 and terminal B 130 is established, depending on whether a message associated with establishing the video data transmission channel with terminal B 130 is received by terminal A 110 from the gateway 120. However, when the gateway 120 exists, the above scheme may not secure whether the data transmission channel is established. Therefore, according to an embodiment of the present invention, terminal A 110 may verify whether the data transmission channel is established through a scheme of verifying whether a first frame transmitted from terminal B 130 corresponding to a counter party terminal of terminal A 110 is received. Through this, it is possible to more accurately determine a point in time when video transmission is possible between terminal A 110 and terminal B 130.

Specifically, if a first frame of video data is received from terminal B 130, terminal A 110 may determine that video data transmission with terminal B 130 is possible. Conversely, if video data is not received from terminal B 130, terminal A 110 may determine that video data transmission with terminal B 130 is not possible.

When the data transmission channel is established, terminal A 110 may determine that the intra frame is received by terminal B 130. Conversely, when the data transmission channel is not established, terminal A 110 may determine that the intra frame is not received by terminal B 130.

If video data transmission between terminal A 110 and terminal B 130 is possible, that is, a “yes” direction in operation S230, terminal A 110 may change the generation interval of the intra frame in operation S240. Specifically, terminal A 110 may change the generation interval of the intra frame from the first interval to the second interval.

Here, the second interval may be longer than the first interval and may also be the same as or similar to the generation interval of the general intra frame. Specifically, the second interval may be longer than the first interval. Also, terminal A 110 may generate the second interval to be the same as or similar to the generation interval of the general intra frame and thereby transmit the intra frame to terminal B 130 at the second interval.

For example, terminal A 110 may change the generation interval of the intra frame from “once every two frames” to “once every twenty frames”. Therefore, terminal A 110 may set the changed generation interval “once every twenty frames” as a new generation interval of the intra frame.

Conversely, if video data transmission between terminal A 110 and terminal B 130 is not possible, that is, a “no” direction in operation S230, terminal A 110 may perform operation S220 until the video data transmission with terminal B 130 becomes possible. However, terminal A 110 may not perform operation S220 indefinitely if video data transmission with terminal B 130 remains not possible. For example, terminal A 110 may give a user an option to disconnect if video data transmission with terminal B 130 remains not possible for a certain period of time.

In operation S250, terminal A 110 may transmit the intra frame to terminal B 130 at the changed generation interval, that is, at the second interval. In the above example, terminal A 110 may transmit the intra frame to terminal B 130 at intervals of “once every twenty frames”. Specifically, terminal A 110 may adopt a scheme of transmitting the intra frame as a first frame and consecutively transmitting the inter frame nineteen times.

As described above, once the video data transmission with terminal B 130 is possible, terminal A 110 may change the generation interval of the intra frame. Through this, it is possible to reduce the network load after a point in time when video data transmission with terminal B 130 is determined to be possible. The network load may occur due to more frequent transmission of the intra frame in the early stage of video telephony, that is, before a point in time when video data transmission with terminal B 130 is determined to be possible. Therefore, terminal A 110 may reduce the risk of video degradation that might otherwise occur in terminal B 130 in the early stage of video telephony.

According to an exemplary embodiment of the present invention, video telephony protocols of terminal A 110 and terminal B 130 may include video telephony and any subsequently developed protocols in a packet network such as H.324, H.324M and 3G H.324M similar to H.324, H.323, Session Initiation Protocol (SIP), and the like. According to an exemplary embodiment of the present invention, not only in a system using a gateway but also when access is made using the same protocol, it is possible to apply the same mechanism and thereby reduce the risk of video degradation caused by data loss in a transmission layer.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD-ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by a computer using an interpreter. The described hardware devices may be configured to act as one or more software modules in order to perform the operations of the above-described exemplary embodiments of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for transmitting video data in a video telephony system, comprising:
generating an intra frame at a first interval;
transmitting the intra frame from a calling terminal to a receiving terminal; and
generating the intra frame at a second interval to transmit the generated intra frame to the receiving terminal.

2. The method of claim 1, wherein generating the intra frame at the second interval comprises:
changing a generation interval of the intra frame from the first interval to the second interval, the second interval being different from the first interval; and
generating the intra frame at the second interval.

3. The method of claim 1, wherein the first interval is shorter than the second interval.

4. The method of claim 1, wherein in the first interval, the calling terminal transmits the intra frame to the receiving terminal every two frames.

5. The method of claim 1, wherein in the second interval, the calling terminal transmits the intra frame to the receiving terminal every twenty frames.

6. The method of claim 1, wherein generating the intra frame at the first interval comprises:
generating the intra frame at the first interval after data transmission between the calling terminal and a gateway becomes possible, wherein the gateway relays a communication between the calling terminal and the receiving terminal.

7. The method of claim 1, further comprising:
determining that data transmission with the calling terminal is possible; and
generating the intra frame at the second interval after determining that data transmission with the receiving terminal is possible.

8. The method of claim 7, wherein the calling terminal determines that data transmission with the receiving terminal is possible if video data is received from the receiving terminal.

9. The method of claim 1, wherein:
the calling terminal and the receiving terminal use different protocols.

10. The method of claim 9, wherein:
the calling terminal uses a packet switching based protocol, and the receiving terminal uses a circuit switching based protocol.

11. A computer comprising a computer-readable recording medium and a processor, the computer to execute a program stored on the computer-readable recording medium to implement the method of claim 1.

12. A mobile terminal, comprising:
a video codec to generate an intra frame and an inter frame for performing video telephony;
an image sensor to capture image data;
a display; and
a radio frequency (RF) transceiver to transmit and receive data,
wherein the video codec generates the intra frame at a first interval after determining that video data transmission with a gateway is possible, and generates the intra frame at a second interval after determining that video data transmission with a receiving terminal is possible.

13. The mobile terminal of claim 12, wherein video data transmission with a receiving terminal is determined to be possible if the RF transceiver receives video data from the receiving terminal.

14. The mobile terminal of claim 12, wherein the first interval is shorter than the second interval.

15. The mobile terminal of claim 12, wherein in the first interval, the mobile terminal transmits the intra frame to the receiving terminal every two frames.

16. The mobile terminal of claim 12, wherein in the second interval, the mobile terminal transmits the intra frame to the receiving terminal every twenty frames.
